(19) United States
(12) Patent Application Publication
(10) Pub. No.: US 2013/0228695 A1
(43) Pub. Date: Sep. 5, 2013

(54) DEVICE FOR COLLECTING EXTREME ULTRAVIOLET LIGHT

(71) Applicant: GIGAPHOTON INC., Oyama-shi (JP)

(72) Inventors: Hakaru MIZOGUCHI, Oyama-shi (JP); Osamu WAKABAYASHI, Oyama-shi (JP)

(73) Assignee: GIGAPHOTON INC., Oyama-shi (JP)

(21) Appl. No.: 13/769,166

(22) Filed: Feb. 15, 2013

(30) Foreign Application Priority Data
Mar. 1, 2012 (JP) 2012-045455
Nov. 29, 2012 (JP) 2012-261425

(51) Int. Cl. G02B 5/08

(52) U.S. Cl. CPC G02B 5/0891
USPC 250/372; 359/350

(57) ABSTRACT

A device for collecting EUV light from a plasma generation region includes first and second EUV collector mirrors. The first EUV collector mirror has a first spheroidal reflective surface and arranged such that a first focus of the first spheroidal reflective surface lies in the plasma generation region and a second focus of the first spheroidal reflective surface lies in a predetermined intermediate focus region. The second EUV collector mirror has a second spheroidal reflective surface and arranged such that a third focus of the second spheroidal reflective surface lies in the plasma generation region and a fourth focus of the second spheroidal reflective surface lies in the predetermined intermediate focus region.

### CROSS-REFERENCE TO RELATED APPLICATIONS

The present application claims priority from Japanese Patent Application No. 2012-045455 filed Mar. 1, 2012, and Japanese Patent Application No. 2012-261425 filed Nov. 29, 2012.

### BACKGROUND

1. Technical Field

The present disclosure relates to a device for collecting extreme ultraviolet (EUV) light.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A device for collecting EUV light emitted at a plasma generation region according to one aspect of the present disclosure may include a first EUV collector mirror having a first spheroidal reflective surface and arranged such that a first focus of the first spheroidal reflective surface lies in the plasma generation region and a second focus of the first spheroidal reflective surface lies in a predetermined intermediate focus region, and a second EUV collector mirror having a second spheroidal reflective surface and arranged a third focus of the second spheroidal reflective surface lies in the plasma generation region and a fourth focus of the second spheroidal reflective surface lies in the predetermined intermediate focus region.

### BRIEF DESCRIPTION OF THE DRAWINGS

Hereinafter, selected embodiments of the present disclosure will be described with reference to the accompanying drawings.

FIG. 1 schematically illustrates a configuration of an exemplary LPP type EUV light generation apparatus.

FIG. 2 is a sectional view, taken along a YZ plane, schematically illustrating an exemplary configuration of an EUV light generation apparatus to which a device for collecting EUV light is applied according to a first embodiment of the present disclosure.

FIG. 3 schematically illustrates a state where radiation is reflected by first and second EUV collector mirrors.

FIG. 4 schematically illustrates first and second far field patterns to be formed in an exposure apparatus.

FIG. 5 is a sectional view, taken along a YZ plane, schematically illustrating an exemplary configuration of an EUV light generation apparatus to which a device for collecting EUV light is applied according to a second embodiment of the present disclosure.

FIG. 6 schematically illustrates exemplary configurations of first and second adjustment stages.

FIG. 7A shows radiation reflected by a first EUV collector mirror entering a focus detection unit.

FIG. 7B shows an example of a result to be obtained by the focus detection unit shown in FIG. 7A.

FIG. 8A shows radiation reflected by a second EUV collector mirror entering a focus detection unit.

FIG. 8B shows an example of a result to be obtained by the focus detection unit shown in FIG. 8A.

FIG. 9 is a flowchart showing a main flow of an operation in which an EUV light generation controller controls a focus state at the intermediate focus.

FIG. 10 is a flowchart showing a subroutine of an operation in which an adjustment controller controls the posture of the first EUV collector mirror.

FIG. 11 is a flowchart showing a subroutine of an operation in which an adjustment controller controls the posture of the first EUV collector mirror.

FIG. 12 is a flowchart showing a subroutine of an operation in which an adjustment controller controls the posture of the second EUV collector mirror.

FIG. 13 is a flowchart showing a subroutine of an operation in which an adjustment controller controls the posture of the second EUV collector mirror.

FIG. 14 is a sectional view, taken along a YZ plane, schematically illustrating an exemplary configuration of an EUV light generation apparatus to which a device for collecting EUV light is applied according to a third embodiment of the present disclosure.

FIG. 15 is a sectional view schematically illustrating an exemplary configuration of the EUV light generation apparatus, taken along an XZ plane.

FIG. 16A shows an example of radiation reflected by the first EUV collector mirror entering a focus detection unit.

FIG. 16B shows an example of a result to be obtained by the focus detection unit shown in FIG. 16A.

FIG. 17 is a sectional view, taken along a YZ plane, schematically illustrating an exemplary configuration of an EUV light generation apparatus to which a device for collecting EUV light is applied according to a fourth embodiment of the present disclosure.

FIG. 18 schematically illustrates an exemplary configuration of a controller.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, configurations and operations described in each embodiment are not all essential in implementing the present disclosure. Note that like elements are referenced by like reference numerals and characters, and duplicate descriptions thereof will be omitted herein.

### Contents

### 1. Overview of EUV Light Generation System

### 1.1 Configuration

### 1.2 Operation

### 2. EUV Light Generation Apparatus Including Device for Collecting EUV Light

### 2.1 Terms

### 2.2 Overview

### 2.3 First Embodiment

### 2.3.1 Configuration

### 2.3.2 Operation

### 2.4 Second Embodiment

### 2.4.1 Configuration

### 2.4.1 Operation

### 2.5 Third Embodiment

### 2.5.1 Configuration

### 2.5.2 Operation

### 2.6 Fourth Embodiment

### 2.6.1 Configuration

### 2.6.2 Operation

### 3. Configuration of Controller

### 1 Overview of EUV Light Generation System

### 1.1 Configuration

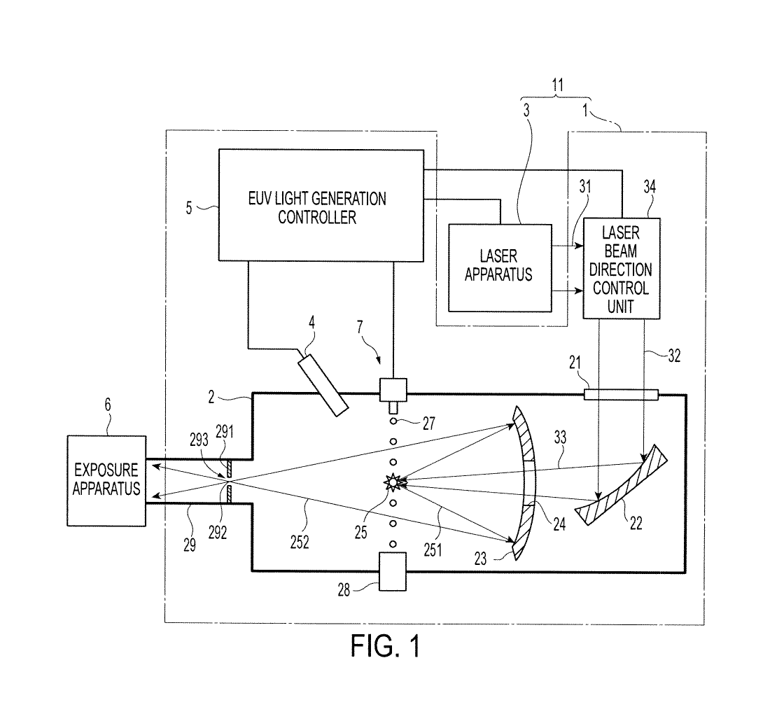

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 7. The chamber 2 may be sealed airtight. The target supply device 7 may be mounted onto the chamber 2, for example, to penetrate a wall of the chamber 2. A target material to be supplied by the target supply device 7 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 1.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 7 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 31 travels, and the position at which the pulse laser beam 33 is focused. It will be appreciated that the various controls mentioned above are merely examples, and other controls may be added as necessary.

### 2. EUV Light Generation Apparatus Including Device for Collecting EUV Light

### 2.1 Terms

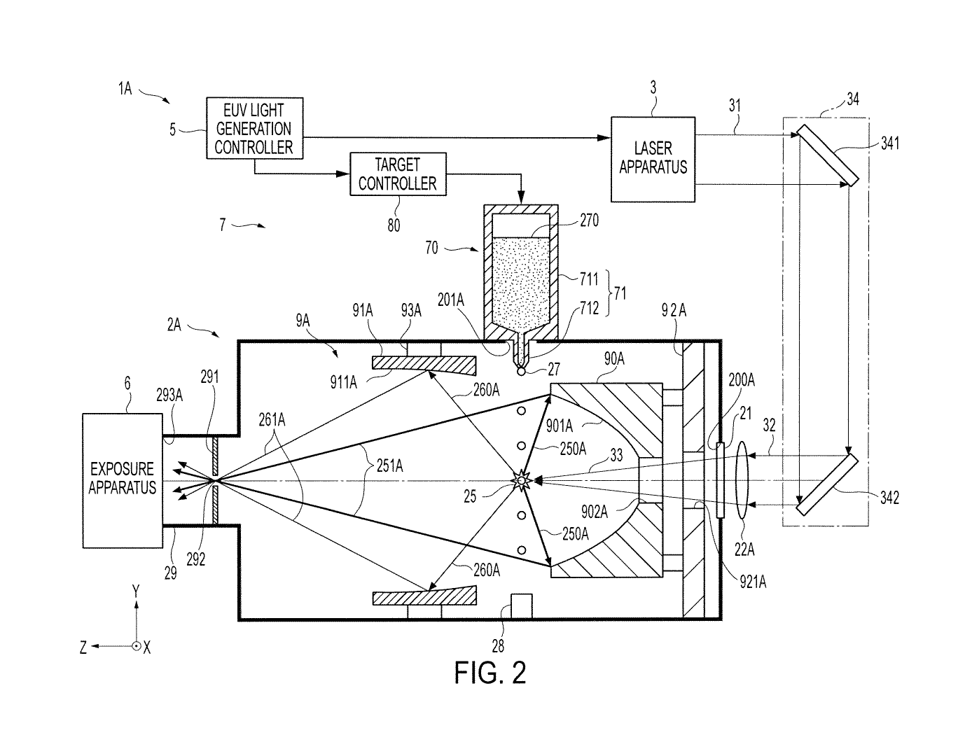

When a wall of an EUV generation chamber shown in FIGS. 2, 5, 14, 15, and 17 is identified, a wall extending in a direction perpendicular to the +Y direction may be referred to as an “upper wall,” a wall extending in a direction perpendicular to the −Y direction may be referred to as a “lower wall,” a wall extending in a direction perpendicular to the +Z direction may be referred to as a “left wall,” a wall extending in a direction perpendicular to the −Z direction may be referred to as a “right wall,” a wall extending in a direction perpendicular to the +X direction may be referred to as a “front wall,” and a wall extending in a direction perpendicular to the −X direction may be referred to as a “rear wall.”

### 2.2 Overview

In an LPP-type EUV light generation apparatus, a collector mirror having a large solid angle may be used in order to improve efficiency of collecting EUV light. In order to increase a solid angle of a collector mirror, a reflective surface thereof may, for example, be extended in a direction along the rotation axis of a spheroid. However, if the reflective surface is to be extended in the direction of the rotation axis, a distance in which tools for processing the reflective surface are moved in the rotation axis direction may be increased, and an existing member for holding the tools may not withstand such load. Thus, it may be difficult to process the entire reflective surface of such a collector mirror having an extended reflective surface.

In one or more embodiments of the present disclosure, a device for collecting EUV light may include first and second EUV collector mirrors arranged confocally with each other. This configuration may make it possible to secure a greater reflective region that, in total, has a large solid angle.

### 2.3 First Embodiment

### 2.3.1 Configuration

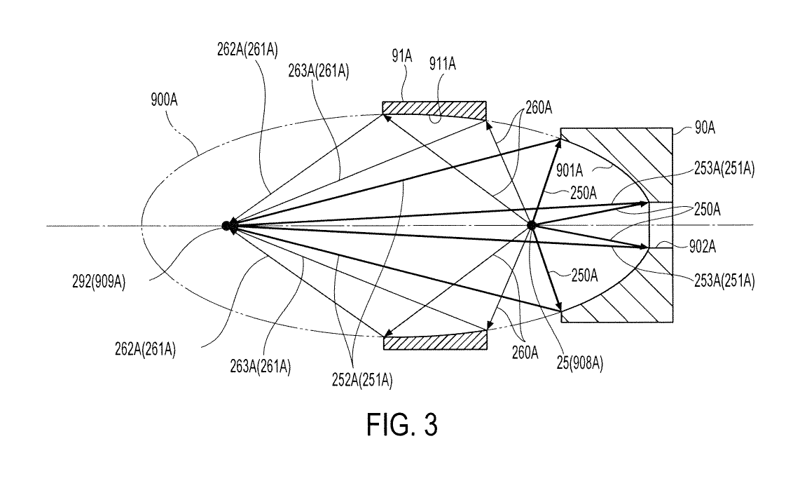

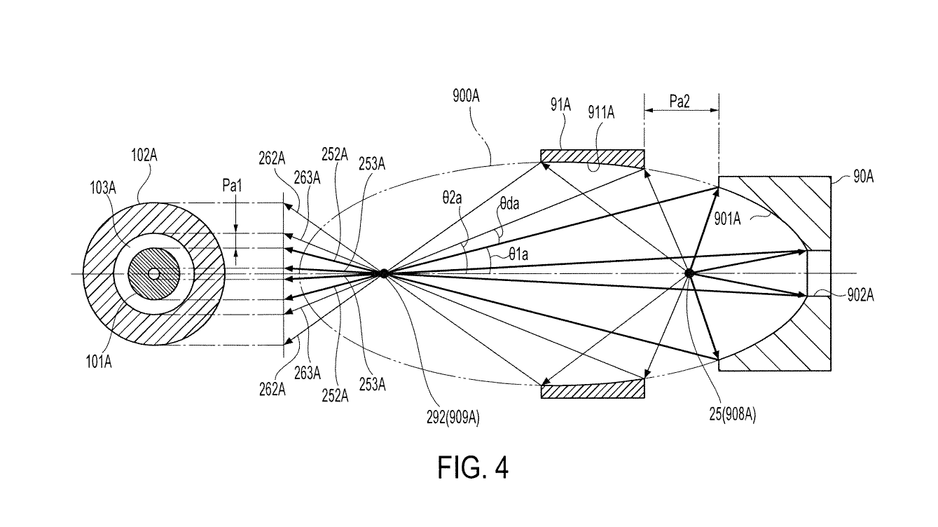

FIG. 2 is a sectional view, taken along a YZ plane, schematically illustrating an exemplary configuration of an EUV light generation apparatus to which a device for collecting EUV light is applied according to a first embodiment of the present disclosure. FIG. 3 schematically illustrates a state where radiation is reflected by first and second EUV collector mirrors. FIG. 4 schematically illustrates first and second far field patterns to be formed in an exposure apparatus.

As shown in FIG. 2, an EUV light generation apparatus 1A may include an chamber 2A and a target supply device 7. The target supply device 7 may include a target generation unit 70 and a target controller 80.

The target generation unit 70 may include a target generator 71 and a pressure adjuster (not separately shown). The target generator 71 may include a tank 711 for storing a target material 270 thereinside. The tank 711 may be cylindrical in shape. The tank 711 may include a nozzle 712, and the target material 270 stored inside the tank 711 may be outputted through the nozzle 712 into the chamber 2A as targets 27. A nozzle opening may be formed at a tip of the nozzle 712. The target generator 71 may be mounted to the chamber 2A such that the tank 711 is located outside the chamber 2A and the nozzle 712 is located inside the chamber 2A. The aforementioned pressure adjuster may be connected to the tank 711.

A first through-hole 200A serving as a laser beam inlet may be formed in the right wall of the chamber 2A, and the pulse laser beam 33 may enter the chamber 2A through the first through-hole 200A. The first through-hole 200A may be covered by the window 21. Further, a second through-hole 201A may be formed in the upper wall of the chamber 2A. The nozzle 712 may be fitted in the second through-hole 201A such that targets 27 are introduced into a space formed between a first EUV collector mirror 90A and a second EUV collector mirror 91A.

As shown in FIGS. 2 and 3, an EUV light collection device 9A may be provided inside the chamber 2A. The EUV light collection device 9A may include the first EUV light collector mirror 90A and the second EUV collector mirror 91A. The first EUV collector mirror 90A may include a first reflective surface 901A. The first reflective surface 901A may be spheroidal in shape and positioned such that a first focus lies in the plasma generation region 25 and a second surface lies in the intermediate focus region 292. To be more specific, with reference to FIG. 3, the first reflective surface 901A may have a shape corresponding to a part of a spheroid 900A that has a first focus 908A, which may coincide with the plasma generation 25 in the description to follow, and a second focus 909A, which may coincide with the intermediate focus region 292 in the description to follow.

Referring back to FIG. 2, the first EUV collector mirror 90A may be arranged toward the right wall of the chamber 2A and attached to a first holder 92A. A through-hole 902A may be formed in the first EUV collector mirror 90A to penetrate the first EUV collector mirror 90A in the major axis direction, and the pulse laser beam 33 may travel through the through-hole 902A toward the plasma generation region 25. A through-hole 921A may be formed in the first holder 92A and aligned with the through-hole 902A coaxially, so that the pulse laser beam 33 may travel through the through-hole 921A toward the plasma generation region 25.

The second EUV collector mirror 91A may include a second reflective surface 911A. The second reflective surface 911A may be spheroidal in shape and positioned confocally with the first EUV collector mirror 90A. To be more specific, with reference to FIG. 3, the second reflective surface 911A may have a shape corresponding to another part of the spheroid 900A, the part being different from that of the first reflective surface 901A.

Referring back to FIG. 2, the second EUV collector mirror 91A may be fixed to the chamber 2A through a second holder 93A. The second EUV collector mirror 91A may be provided on the side of the left wall relative to the position of the first EUV collector mirror 90A such that a space that contains the plasma generation region 25 is secured between the first EUV collector mirror 90A and the second EUV collector mirror 91A.

With the above-described arrangement, radiation 250A may be incident on the first reflective surface 901A at an angle smaller than an angle at which radiation 260A is incident on the second reflective surface 911A. Here, the radiation 250A and the radiation 260A may include EUV light emitted from plasma generated in the plasma generation region 25. The first reflective surface 901A may be formed of a multi-layered reflective film that includes a molybdenum layer and a silicon layer which are alternately laminated. The multi-layered reflective film configured as such may selectively reflect EUV light included in the radiation 250A incident thereon at a small angle. Meanwhile, the second reflective surface 911A may be formed of a single layer reflective film that includes a ruthenium layer. The second reflective surface 911A configured as such may selectively reflect EUV light included in the radiation 260A incident thereon at a large angle.

Further, as shown in FIG. 2, an opening 293A may be defined in the connection part 29 and the connection part 29 may be connected to the exposure apparatus 6 through the opening 293A. Radiation 251A reflected by the first EUV collector mirror 90A and radiation 261A reflected by the second EUV collector mirror 91A may be outputted to the exposure apparatus 6 from the chamber 2A through the opening 293A.

Further, the EUV light generation apparatus 1A may include the laser beam direction control unit 34 and a laser beam focusing optical system 22A. The laser beam direction control unit 34 may include a first optical element 341 and a second optical element 342 for defining a direction in which the pulse laser beam 32 travels. The laser beam focusing optical system 22A may comprise a single mirror instead of a lens as shown in FIG. 2.

### 2.3.2 Operation

With reference to FIG. 2, the pulse laser beam 31 outputted from the laser apparatus 3 may reach the plasma generation region 25 as the pulse laser beam 33 through the laser beam direction control unit 34, the laser beam focusing optical system 22A, and the window 21. Further, a target 27 may be outputted from the target generator 70 toward the plasma generation region 25 and irradiated with the pulse laser beam 33. Upon being irradiated with the pulse laser beam 33, the target 27 may be turned into plasma, and the radiation 250A and the radiation 260A may be emitted therefrom. Here, for the sake of convenience, the radiation 250A may refer to a part of isotropic radiation from the plasma emitted toward the first EUV collector mirror 90A, and the radiation 260A may refer to another part of the isotropic radiation from the plasma emitted toward the second EUV collector mirror 260A.

The radiation 250A may be reflected by the first reflective surface 901A of the first EUV collector mirror 90A and outputted as the radiation 251A to the exposure apparatus 6 through the intermediate focus region 292. Similarly, the radiation 260A may be reflected by the second reflective surface 911A of the second EUV collector mirror 91A and outputted as the radiation 261A to the exposure apparatus 6 through the intermediate focus region 292.

To be more specific, with reference to FIG. 3, a part of the radiation 251A which is reflected by an outer peripheral portion of the first reflective surface 901A may be focused in the intermediate focus region 292 as radiation 252A. A part of the radiation 251A which is reflected by an edge of the first reflective surface 901A around the through-hole 902A may be focused in the intermediate focus region 292 as radiation 253A. In this way, the first EUV collector mirror 90A may focus the radiation 250A incident on the first reflective surface 901A in the intermediate focus region 292.

Further, a part of the radiation 261A which is reflected by an edge of the second reflective surface 911A on the side of the intermediate focus region 292 may be focused in the intermediate focus region 292 as radiation 262A. Another part of the radiation 261A which is reflected by an edge of the second reflective surface 911A on the side of the first EUV collector mirror 90A may also be focused in the intermediate focus region 292 as radiation 263A. In this way, the second EUV collector mirror 91A may focus the radiation 260A incident on the second reflective surface 911A in the intermediate focus region 292.

Then, as shown in FIG. 4, an annular first far field pattern 101A of the radiation 251A from the first EUV collector mirror 90A may be seen inside the exposure apparatus 6. The inner circumference of the first far field pattern 101A may be defined by the radiation 253A, and the outer circumference thereof may be defined by the radiation 252A. Further, an annular second far field pattern 102A of the radiation 261A from the second EUV collector mirror 91A may be formed to surround the first far field pattern 101A. The inner circumference of the second far field pattern 102A may be defined by the radiation 263A, and the outer circumference thereof may be defined by the radiation 262A. An annular dark section 103A may be formed between the first far field pattern 101A and the second far field pattern 102A.

The dark section 103A may be a region that is not irradiated with the radiation 251A and the radiation 261A. A dimension Pa1 of the annular dark section 103A will be described. With respect to a straight line that connects the first focus 908A and the second focus 909A, an angle formed with a path of the radiation 252A is designated as 81a, and an angle formed with a path of the radiation 263A is designated as θ2a. The dimension Pa1 may correspond to a difference θda between the angles θ1a and θ2a as expressed through θ2a−θ1a=θda. This difference θda may correspond to a dimension Pa2 of spacing between the first EUV collector mirror 90A and the second EUV collector mirror 91A.

As described above, the EUV light collection device 9A may includes the first EUV collector mirror 90A and the second EUV collector mirror 91A for focusing the radiation 251A and the radiation 261A, respectively, in the intermediate focus region 292 and guiding into the exposure apparatus 6. The first and second EUV collector mirrors 90A and 91A may be arranged confocally. With the above-described configuration, even if a solid angle of each of the first reflective surface 901A and the second reflective surface 911A is small, a reflective region having, overall, a large solid angle may be formed with the first reflective surface 901A and the second reflective surface 911A combined together.

Further, the EUV light collection device 9A may reflect the radiation 250A and the radiation 260A only once by the first and second reflective surfaces 901A and 911A, respectively, toward in the intermediate focus region 292. This may allow the number of times the radiation 250A and the radiation 260A are reflected to be kept to be the minimum, and the absorption by the first and second reflective surfaces 901A and 911A may be kept to be the minimum.

### 2.4 Second Embodiment

### 2.4.1 Configuration

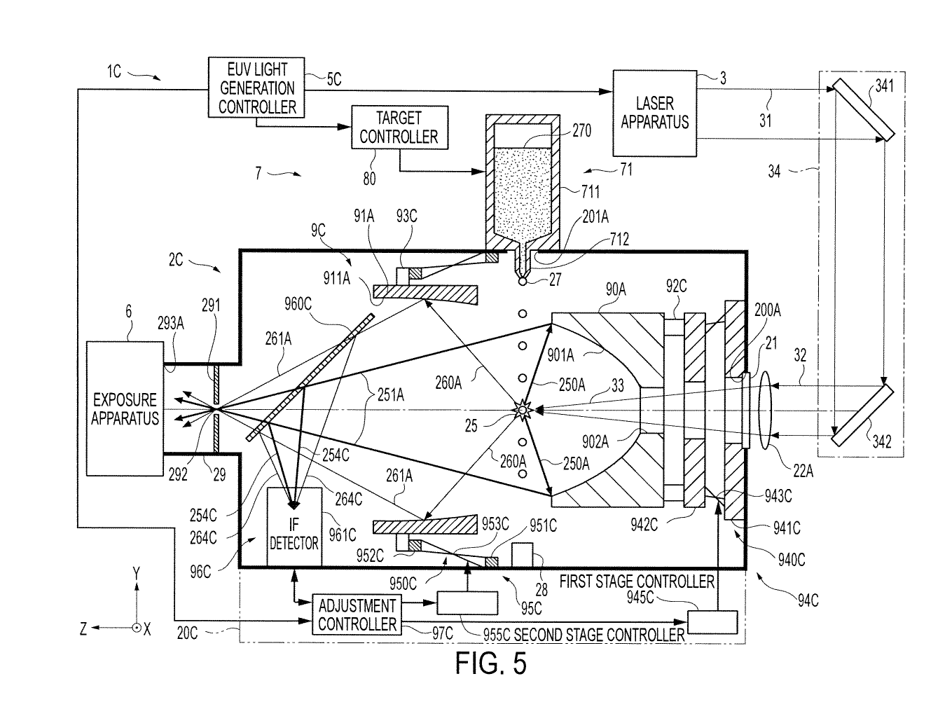

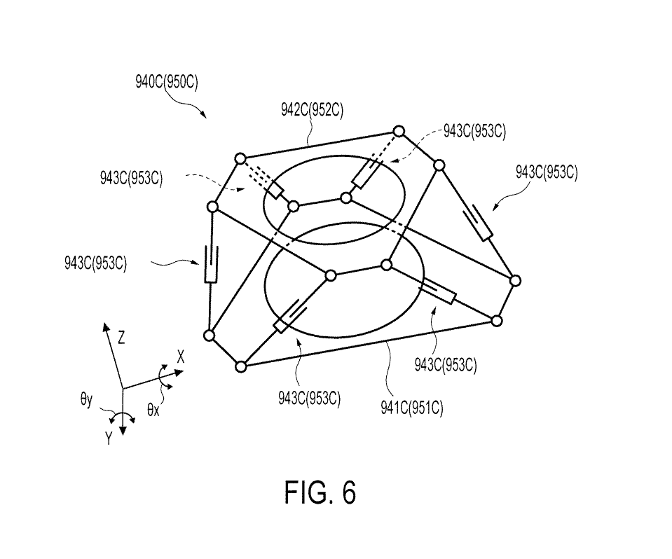

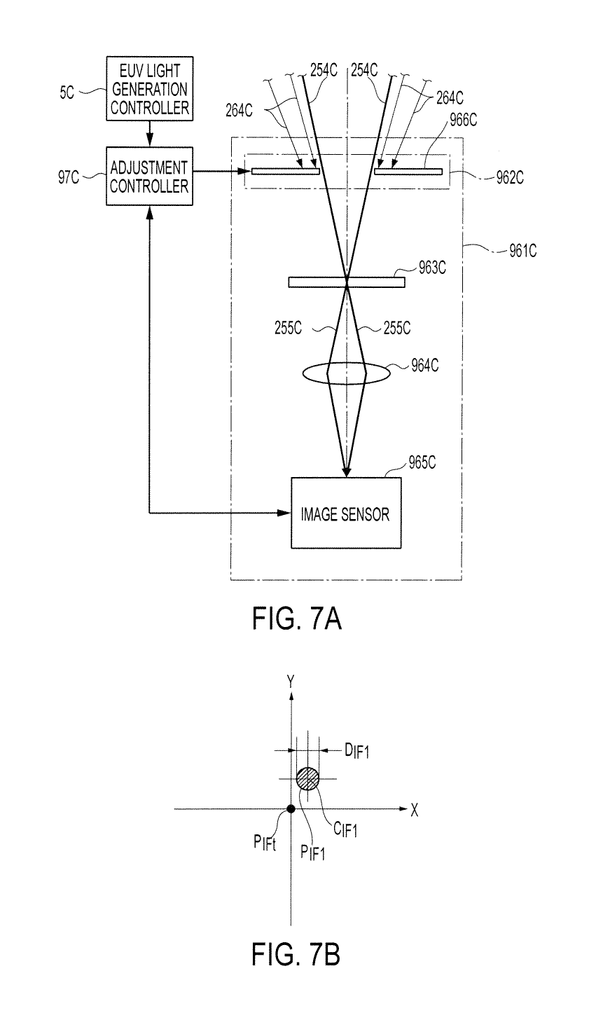

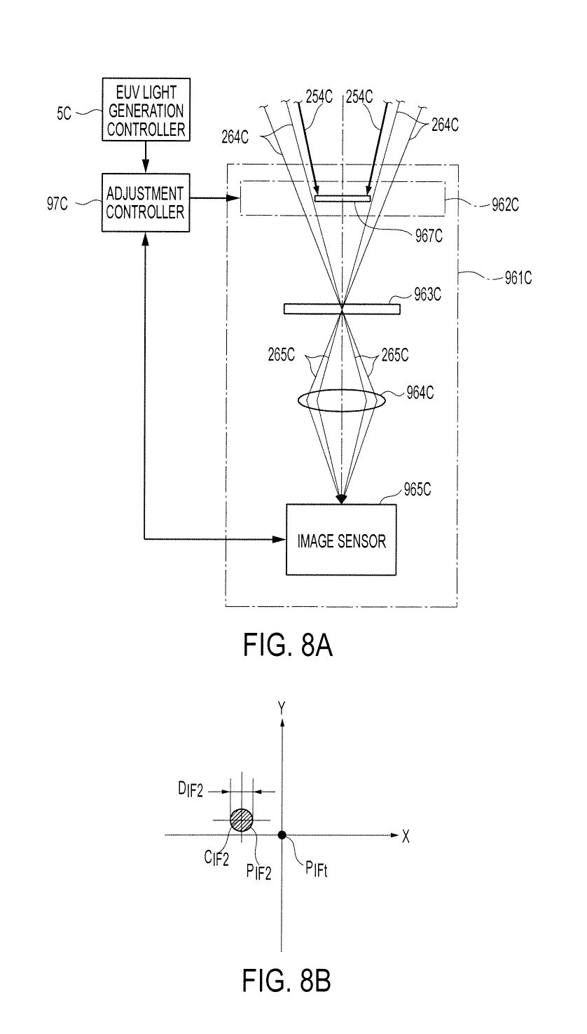

FIG. 5 is a sectional view, taken along a YZ plane, schematically illustrating an exemplary configuration of an EUV light generation apparatus to which a device for collecting EUV light is applied according to a second embodiment of the present disclosure. FIG. 6 schematically illustrates exemplary configurations of first and second adjustment stages. FIG. 7A shows radiation reflected by a first EUV collector mirror entering a focus detection unit. FIG. 7B shows an example of a result to be obtained by the focus detection unit shown in FIG. 7A. FIG. 8A shows radiation reflected by a second EUV collector mirror entering a focus detection unit. FIG. 8B shows an example of a result to be obtained by the focus detection unit shown in FIG. 8A.

As shown in FIG. 5, an EUV light generation apparatus 1C of the second embodiment may differ from the EUV light generation apparatus 1A of the first embodiment in that an EUV light generation controller 5C is provided in place of the EUV light generation controller 5 and an EUV light collection device 9C is provided in place of the EUV light collection device 9A.

The EUV light collection device 9C may further include a first mirror adjuster 94C, a second mirror adjuster 95C, a focus detection unit 96C, and an adjustment controller 97C in addition to those of the EUV light collection device 9A of the first embodiment.

The first mirror adjuster 94C may be configured to adjust the posture of the first EUV collector mirror 90A. The first mirror adjuster 94C may include a first adjustment stage 940C for holding the first EUV collector mirror 90A and a first stage controller 945C for controlling an operation of the first adjustment stage 940C. The first adjustment stage 940C may be a so-called five-axis stage. As shown in FIGS. 5 and 6, the first adjustment stage 940C may include a fixed plate 941C, a movable plate 942C, and six actuators 943C. The fixed plate 941C may have an annular shape and may be fixed to the right wall of the chamber 2C. The movable plate 942C may also have an annular shape and may hold the first EUV collector mirror 90A through a first holder 92C. The six actuators 943C may connect the fixed plate 941C with the movable plate 942C at six points. Each of the actuators 943C may be configured to be deformable. Each of the actuators 943C may be electrically connected to the first stage controller 945C. The first stage controller 945C may be electrically connected to the adjustment controller 97C and may cause each of the actuators 943C to deform under the control of the adjustment controller 97C.

As each of the actuators 943C deforms in accordance with the control of the first stage controller 945C, the posture of the movable plate 942C relative to the fixed plate 941C may be adjusted. In more detail, provided that a face of the fixed plate 941C lies along the XY plane and a line normal thereto coincides with the Z-axis, the movable plate 942C has the posture thereof adjusted along the total of five axes, which includes translation in the X-axis, in the Y-axis, and in the Z-axis, and rotation about the X-axis (θx) and the Y-axis (θy). That is, in relation to the fixed plate 941C, the movable plate 942C translates in the vertical, lateral and longitudinal directions, and tilts along the lateral direction and along the longitudinal direction.

The second mirror adjuster 95C may be provided to adjust the posture of the second EUV collector mirror 91A and may include a second adjustment stage 950C for holding the second EUV collector mirror 91A and a second stage controller 955C for controlling an operation of the second adjustment stage 950C. The second adjustment stage 950C may include a fixed plate 951C, a movable plate 952C, and actuators 953C. The fixed plate 951C may be fixed to an inner wall of the chamber 2C. The movable plate 952C may hold the second EUV collector mirror 91A through a second holder 93C. Each of the actuators 953C may be electrically connected to the second stage controller 955C. The second stage controller 955C may be electrically connected to the adjustment controller 97C and may cause each of the actuators 953C to deform under the control of the adjustment controller 97C. Through the control of the second stage controller 955C, the posture of the second adjustment stage 950C may be adjusted in five axes, as in the first adjustment stage 940C.

As shown in FIG. 5, the focus detection unit 96C may include a splitting optical element 960C and an IF detector 961C. The splitting optical element 960C may be provided between the plasma generation region 25 and the intermediate focus region 292. The splitting optical element 960C may be positioned and configured to reflect a part of the radiation 251A and a part of the radiation 261A toward the IF detector 961C as radiation 254C and radiation 264C, respectively. The splitting optical element 960C may be a plate in which a plurality of openings is formed and may serve as a spectral purity filter. The IF detector 961C may be provided such that the radiation 254C and the radiation 264C from the splitting optical element 960C enter the IF detector 961C. As shown in FIG. 7A, the IF detector 961C may include a shield switching unit 962C, a fluorescent screen 963C, a transfer optical system 964C, and an image sensor 965C.

The shield switching unit 962C may selectively shield either of the radiation 254C and the radiation 264C. As shown in FIG. 7A, the shield switching unit 962C may be electrically connected to the adjustment controller 97C. The shield switching unit 962C may set a first light shielding plate 966C in a path of the radiation 264C to shield the radiation 264C and allow the radiation 254C to pass through under the control of the adjustment controller 97C. Similarly, as shown in FIG. 8A, the shield switching unit 962C may set a second light shielding plate 967C in a path of the radiation 254C to shield the radiation 254C and allow the radiation 264C to pass through. As shown in FIGS. 7A and 8A, the fluorescent screen 963C may be provided along a predetermined focal plane of the radiation 254C and the radiation 264C that have passed through the shield switching unit 962C. The fluorescent screen 963C may be positioned such that a distance between the splitting optical element 960C and the intermediate focus region 292 is substantially the same as a distance between the splitting optical element 960C and the fluorescent screen 963C. As the radiation 254C and the radiation 264C are incident on the fluorescent screen 963C, the fluorescent screen 963C may emit visible light 255C and visible light 265C, respectively. The transfer optical system 964C may be provided in paths of the visible light 255C and the visible light 265C. The transfer optical system 964C may be positioned and configured to focus the visible light 255C and the visible light 265C on the photosensitive surface of the image sensor 965C. That is, the transfer optical system 964C may be positioned to transfer an image of each of the visible light 255C and the visible light 265C along the plane where the fluorescent screen 963C is provided onto the photosensitive surface of the image sensor 965C.

When the visible light 255C is incident on the photosensitive surface of the image sensor 965C, a first image P_{IF1} as shown in FIG. 7B may be formed on the photosensitive surface of the image sensor 965C. Data on the first image P_{IF1} may be sent to the adjustment controller 97C. The image sensor 965C may be electrically connected to the adjustment controller 97C. Upon receiving the data from the image sensor 965C, the adjustment controller 97C may calculate an intensity distribution of the visible light 255C. Further, the adjustment controller 97C may calculate a center C_{IF1} and a diameter D_{IF1} of the first image P_{IF1} from the calculated intensity distribution. As described later, P_{IFt} shown in FIG. 7B indicates a target position of the center C_{IF1}.

Further, when the visible light 265C is incident on the photosensitive surface of the image sensor 965C, a second image P_{IF2} as shown in FIG. 8B may be formed on the photosensitive surface of the image sensor 965C. Data on the second image PIF2 may be sent to the adjustment controller 97C. Upon receiving the data from the image sensor 965C, the adjustment controller 97C may calculate an intensity distribution of the visible light 265C. Further, the adjustment controller 97C may calculate a center C_{IF2} and a diameter D_{IFS} of the second image P_{IF2} from the calculated intensity distribution. As described later, P_{IFt} shown in FIG. 8B indicates a target position of the center C_{IF2}. An operation for bringing the center C_{IF2} to approach P_{IFt} will be described later.

As shown in FIG. 5, the adjustment controller 97C may be housed in a case 20C of the chamber 2C together with the first stage controller 945C and the second stage controller 955C. The adjustment controller 97C may be electrically connected to the EUV light generation controller 5C. The adjustment controller 97C may be configured to control the first stage controller 945C and the second stage controller 955C based on a result of the aforementioned calculation.

### 2.4.2 Operation

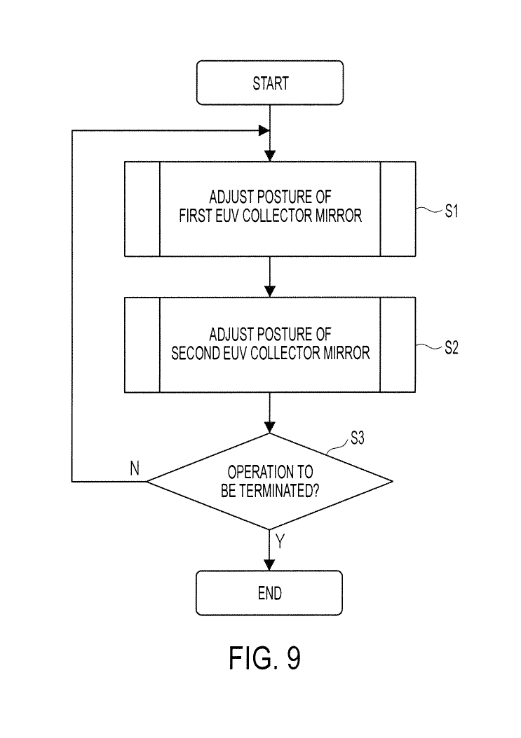

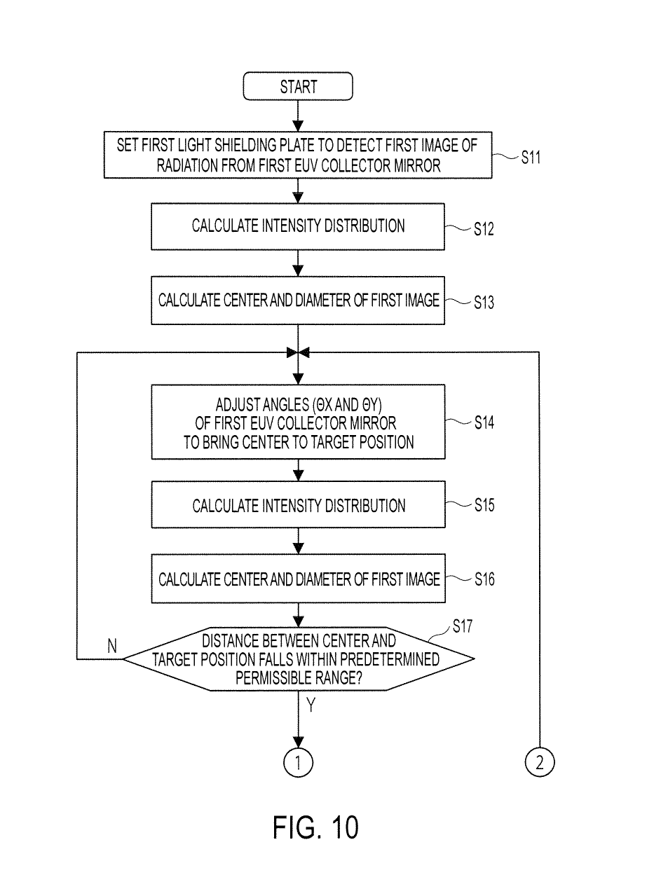

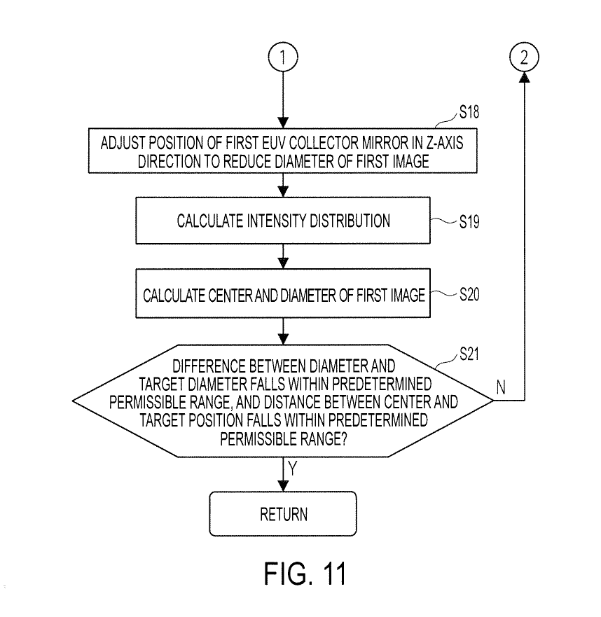

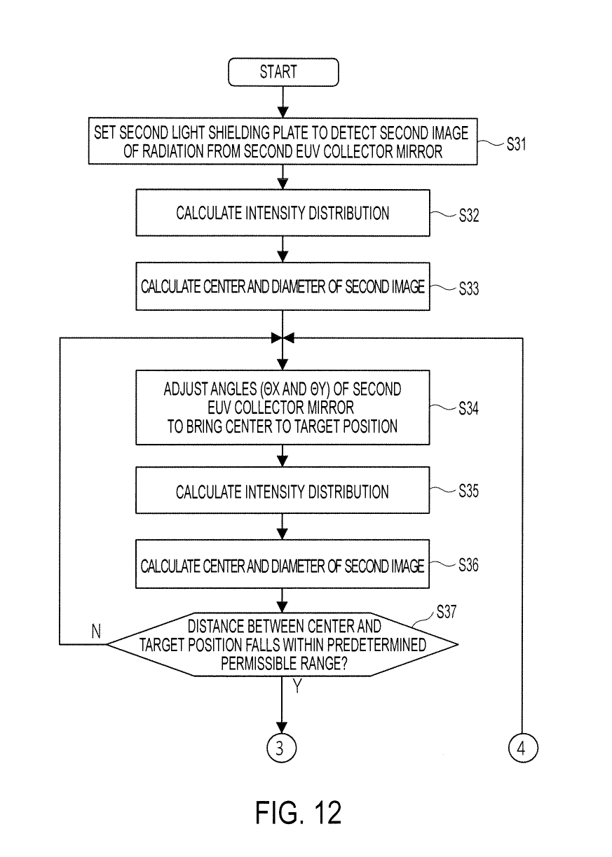

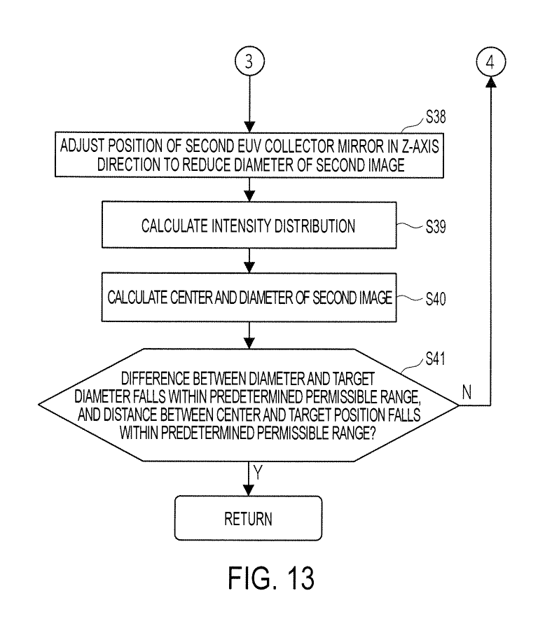

FIG. 9 is a flowchart showing a main flow of an operation in which an EUV light generation controller controls a focus state at the intermediate focus. FIGS. 10 and 11 are flowcharts showing a subroutine of an operation in which an adjustment controller controls the posture of the first EUV collector mirror. FIGS. 12 and 13 are flowcharts showing a subroutine of an operation in which an adjustment controller controls the posture of the second EUV collector mirror. The operation shown in these flowcharts can be performed when the EUV light generation apparatus is in operation to maintain the posture of the first EUV collector mirror to be optimum or when the apparatus is under maintenance.

With reference to FIG. 5, the EUV light generation controller 5C may control the laser apparatus 3 and the target controller 80 to generate the radiation 250A and the radiation 260A. The radiation 250A may be reflected by the first reflective surface 901A and outputted as the radiation 251A to the exposure apparatus 6. The radiation 260A may be reflected by the second reflective surface 911A and outputted as the radiation 261A to the exposure apparatus 6. The splitting optical element 960C may be provided in a path of the radiation 251A, and thus a part of the radiation 251A may be split by the splitting optical element 960C and may enter the IF detector 961C as the radiation 254C. The remaining part of the radiation 251A may be transmitted through the splitting optical element 960C and outputted to the exposure apparatus 6. Similarly, a part of the radiation 261A may be reflected by the splitting optical element 960C and may enter the IF detector 961C as the radiation 264C. The remaining part of the radiation 261A may be transmitted through the splitting optical element 960C and outputted to the exposure apparatus 6.

With reference to FIG. 9, the EUV light generation controller 5C may output an adjustment start signal to the adjustment controller 97C to carry out a control to adjust the focus state of the radiation. This control may be started after the radiation 250A and the radiation 260A are generated. Upon receiving an adjustment start signal, the adjustment controller 97C may carry out a subroutine to control the posture of the first EUV collector mirror 90A (Step S1). Through this control, the posture of the first EUV collector mirror 90A may be adjusted, and thus the radiation 251A from the first EUV collector mirror 90A may be focused in the intermediate focus region 292 in a predetermined state.

With reference to FIG. 10, the adjustment controller 97C may set the first light shielding plate 966C in the shield switching unit 962C (Step S11). Here, the adjustment controller 97C may output a first light shielding plate set signal to the shield switching unit 962C. Upon receiving the first light shielding plate set signal, the shield switching unit 962C may either keep the first light shielding plate 966C if the first light shielding plate 966C is already set or may switch from the second light shielding plate 967C to the first light shielding plate 966C if the second light shielding plate 967C is already set.

When the first light shielding plate 966C is set in the shield switching unit 962C, the radiation 254C may pass through the shield switching unit 962C, as shown in FIG. 7A, and the radiation 254C may be incident on the fluorescent screen 963C. The fluorescent screen 963C on which the radiation 254C is incident may emit the visible light 255C, and the emitted visible light 255C may be transferred onto the photosensitive surface of the image sensor 965C by the transfer optical system 964C. Referring back to FIG. 10, the image sensor 965C may obtain data, or a first image P_{IF1}, indicative of an intensity distribution of the visible light 255C incident on the photosensitive surface thereof (Step S12), and may send the obtained data to the adjustment controller 97C. Upon receiving the data from the image sensor 965C, the adjustment controller 97C may calculate the center C_{IF1} and the diameter D_{IF1} of the first image P_{IF1} (Step S13). At this point, the adjustment controller 97C may also load a target position P_{IFt} from a memory.

The adjustment controller 97C may then control the posture of the first EUV collector mirror 90A so that the center C_{IF1} approaches the target position P_{IFt} (Step S14) through the first mirror adjuster 94C. When the center C_{IF1} is located at the position shown in FIG. 7B, the adjustment controller 97C determines that the center C_{IF1} should be moved toward the lower left in the drawing. Then, the adjustment controller 97C may output a first XY adjustment signal to the first stage controller 945C to adjust the rotation angles θx and θy of the first EUV collector mirror 90A so that the center C_{IF1} moves toward the lower left in the drawing. Upon receiving the first XY adjustment signal, the first stage controller 945C may drive each of the actuators 943C in accordance with the first XY adjustment signal. When each of the actuators 943C is driven, the posture of the first EUV collector mirror 90A may change, and in turn the position of the center C_{IF1} to be detected by the image sensor 965C may change accordingly.

Thereafter, the image sensor 965C may again obtain data on the visible light 255C after the above-described adjustment, and the adjustment controller 97C may calculate the intensity distribution of the visible light 255C (Step S15). Then, based on this calculation result, the adjustment controller 97C may again calculate the center C_{IF1} and the diameter D_{IF1} of the first image P_{IF1} (Step S16). The adjustment controller 97C may then determine whether or not a distance between the center C_{IF1} and the target position P_{IFt} falls within a predetermined permissible range (Step S17). In Step S17, when the adjustment controller 97C determines that the aforementioned difference does not fall within the predetermined permissible range (Step S17; NO), the adjustment controller 97C may return to Step S14 to repeat the subsequent steps. When the adjustment controller 97C determines that the aforementioned difference falls within the predetermined permissible range (Step S17; YES), the adjustment controller 97C may then control the position of the first EUV collector mirror 90A in the Z-axis direction so that the diameter D_{IF1} of the first image P_{IF1} is reduced, as shown in FIG. 11 (Step S18). The adjustment controller 97C may output a first Z adjustment signal to the first stage controller 945C to move the first EUV collector mirror 90A in the Z-axis direction so that the diameter D_{IF1} is reduced. Upon receiving a first Z adjustment signal, the first stage controller 945C may drive each of the actuators 943C in accordance with the received first Z adjustment signal. As each of the actuators 943C is driven, the position of the first EUV collector mirror 90A in the Z-axis direction may change, and in turn the diameter D_{IF1} to be obtained by the image sensor 965C may change accordingly.

Thereafter, the image sensor 965C may again obtain data on the visible light 255C and send the data to the adjustment controller 97C. Upon receiving the data from the image sensor 965C, the adjustment controller 97C may again calculate the intensity distribution of the visible light 255C (Step S19), and may also calculate the center C_{IF1} and the diameter D_{IF1} of the first image P_{IF1} (Step S20). Then, the adjustment controller 97C may determine whether or not a difference between the calculated diameter D_{IF1} and a target diameter falls within a predetermined permissible range and a distance between the center C_{IF1} and the target position P_{IFt} falls within a predetermined permissible range (Step S21). Here, the adjustment controller 97C may load the aforementioned target diameter from a memory. In Step S21, when the adjustment controller 97C determines that at least one of the center C_{IF1} and the diameter D_{IF1} does not meet to the aforementioned conditions (Step S21; NO), the adjustment controller 97C may return to Step S14. At this time, in a case where the diameter D_{IF1} calculated by the adjustment controller 97C is greater than a previous instance of the diameter D_{IF1} as a result of changing the position of the first EUV collector mirror 90A in the Z-axis direction, the direction in which the first EUV collector mirror 90A is to be moved in the Z-axis direction for the next instance may be reversed. In Step S21, when the adjustment controller 97C determines that both the center C_{IF1} and the diameter D_{IF1} meet the aforementioned conditions, the adjustment controller 97C may terminate the control to adjust the posture of the first EUV collector mirror 90A.

As described thus far, by adjusting the posture of the first EUV collector mirror 90A such that the difference between the diameter Dᵢₙ and the target diameter of the first image P_{IFt} falls within the predetermined permissible range and the distance between the center C_{IF1} and the target position P_{IFt} falls within the predetermined permissible range, the radiation 251A from the first EUV collector mirror 90A may be focused appropriately at the intermediate focus region 292.

Referring back to FIG. 9, the adjustment controller 97C may then control the posture of the second EUV collector mirror 91A (Step S2). Through this control, the posture of the second EUV collector mirror 91A may be adjusted, and thus the radiation 261A reflected by the second EUV collector mirror 91A may be focused in the intermediate focus region 292 in a preset state.

With reference to FIG. 12, the adjustment controller 97C may set the second light shielding plate 967C in the shield switching unit 962C (Step S31). Here, the adjustment controller 97C may output a second light shielding plate set signal to the shield switching unit 962C. Upon receiving the second light shielding plate set signal, the shield switching unit 962C may either keep the second light shielding plate 967C if the second light shielding plate 967C is already set or may switch from the first light shielding plate 966C to the second light shielding plate 967C if the first light shielding plate 966C is already set. As shown in FIG. 8A, when the second light shielding plate 967C is set in the shield switching unit 962C, the radiation 264C may pass through the shield switching unit 962C, and may be incident on the fluorescent screen 963C. The fluorescent screen 963C on which the radiation 264C is incident may emit the visible light 265C, and the emitted visible light 265C may be transferred onto the photosensitive surface of the image sensor 965C by the transfer optical system 964C. Referring back to FIG. 12, the image sensor 965C may obtain data, or a second image P_{IF2} indicative of the intensity distribution of the visible light 265C (Step S32), and send the obtained data to the adjustment controller 97C. Upon receiving the data from the image sensor 965C, the adjustment controller 97C may calculate a center C_{IF2} and a diameter D_{IF2} of the second image P_{IF2} (Step S33).

The adjustment controller 97C may control the posture of the second EUV collector mirror 91A through the second mirror adjuster 95C so that the center C_{IF2} approaches the target position P_{IFt} (Step S34). When the center C_{IF2} is located at a position shown in FIG. 8B, the adjustment controller 97C determines that the center C_{IF2} should be moved toward the lower right in the drawing. Then, the adjustment controller 97C may output a second XY adjustment signal to the second stage controller 9550 to adjust the rotation angles θx and θy of the second EUV collector mirror 91A so that the center C_{IF2} moves toward the lower right in the drawing. Upon receiving a second XY adjustment signal, the second stage controller 955C may drive each of the actuators 953C in accordance with the received second XY adjustment signal. As each of the actuators 953C is driven, the posture of the second EUV collector mirror 91A may change, and in turn the position of the center C_{IF2} to be detected by the image sensor 965C may change accordingly.

Thereafter, the image sensor 965C may again obtain data indicative of the intensity distribution of the visible light 265C and sent the data to the adjustment controller 97C. Upon receiving the data, the adjustment controller 97C may again calculate the intensity distribution of the visible light 265C (Step S35). Further, the adjustment controller 97C may again calculate the center C_{IF2} and the diameter D_{IF2} from the calculated intensity distribution (Step S36). Then, the adjustment controller 97C may determine whether or not a distance between the center C_{IF2} and the target position P_{IFt} falls within a predetermined permissible range based on a calculation result (Step S37). In Step S37, when the adjustment controller 97C determines that the aforementioned difference does not fall within the predetermined permissible range (Step S37; NO), the adjustment controller 97C may return to Step S34 to repeat the subsequent steps. When the adjustment controller 97C determines that the aforementioned difference falls within the predetermined permissible range (Step S37; YES), the adjustment controller 97C may then control the position of the second EUV collector mirror 91A in the Z-axis direction so that the diameter D_{IF2} of the second image P_{IF2} is reduced, as shown in FIG. 13 (Step S38). To be more specific, the adjustment controller 97C may output a second Z adjustment signal to the second stage controller 955C to move the second EUV collector mirror 91A in the Z-axis direction so that the diameter D_{IF2} is reduced. The second stage controller 955C may drive each of the actuators 953C in accordance with the received second Z adjustment signal. As each of the actuators 953C is driven, the position of the second EUV collector mirror 91A in the Z-axis direction may change, and in turn the diameter D_{IF2} to be detected by the image sensor 965C may change accordingly.

Thereafter, the image sensor 965C may again obtain data on the visible light 265C, and send the data to the adjustment controller 97C. Upon receiving the data, the adjustment controller 97C may calculate the intensity distribution of the visible light 265C (Step S39), and may again calculate the center C_{IF2} and the diameter D_{IF2} from the calculated intensity distribution (Step S40). Then, the adjustment controller 97C may determine whether or not a difference between the diameter D_{IF2} and a target diameter and a distance between the center C_{IF2} and the target position P_{IFt} fall within predetermined permissible ranges, respectively (Step S41). In Step S41, when the adjustment controller 97C determines that at least one of the aforementioned conditions is not met, the adjustment controller 97C may return to Step S34. At this time, in a case where the diameter D_{IF2} detected by the image sensor 965C is greater than a previous instance of the diameter D_{IF2} as a result of changing the position of the second EUV collector mirror 91A in the Z-axis direction, the direction in which the second EUV collector mirror 91A is to be moved in the Z-axis direction for the next instance may be reversed. In Step S41, when the adjustment controller 97C determines that both the center C_{IF2} and the diameter D_{IF2} meet the aforementioned conditions, the adjustment controller 97C may terminate the control to adjust the posture of the second EUV collector mirror 91A.

As described above, by adjusting the posture of the second EUV collector mirror 91A such that the difference between the diameter D_{IF2} and the target diameter of the second image P_{IF2} falls within the predetermined permissible range and the distance between the center C_{IF2} and the target position P_{IFt} falls within the predetermined permissible range, the radiation 261A reflected by the second EUV collector mirror 91A may be focused appropriately at the intermediate focus region 292.

Referring back to FIG. 9, the EUV light generation controller 5C may determine whether or not the control of the focus state of the radiation is to be terminated (Step S3). For example, the EUV light generation controller 5C may determine whether or not the EUV light generation controller 5C has been notified of a termination of the control by an operator, through a signal by the exposure apparatus 6, or through a signal from a detector or a controller in the EUV light generation system. When the EUV light generation controller 5C does not receive a termination signal (Step S3; NO), the EUV light generation controller 5C may return to Step S1. When the EUV light generation controller 5C receives the termination signal (Step S3; YES), the EUV light generation controller 5C terminates the control.

As described above, under the control of the EUV light generation controller 5C, the adjustment controller 97C may adjust the postures of the first EUV collector mirror 90A and the second EUV collector mirror 91A, respectively, based on detection results of the visible light 255C and the visible light 265C by the image sensor 965C.

Here, adjusting the posture of one of the first EUV collector mirror 90A and the second EUV collector mirror 91A may be omitted (see, e.g., the third embodiment discussed below). Further, although the configuration for adjusting the rotation angles θx and θy and the position in the Z-axis direction of the first or second EUV collector mirror 90A or 91A is shown above, at least one of the above may be adjusted.

### 2.5 Third Embodiment

### 2.5.1 Configuration

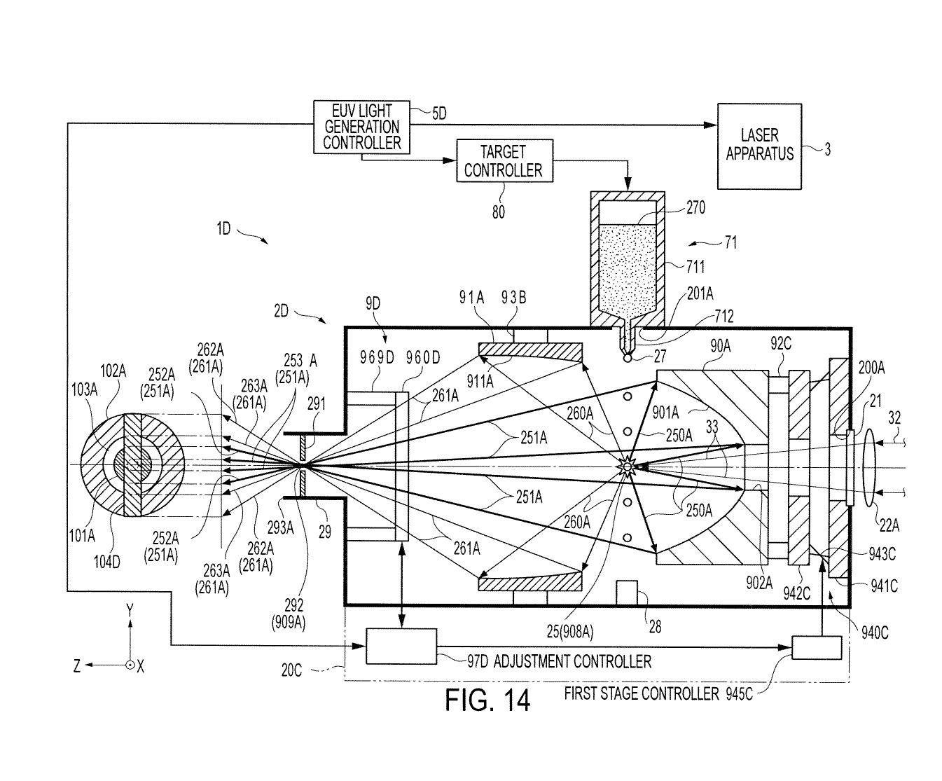

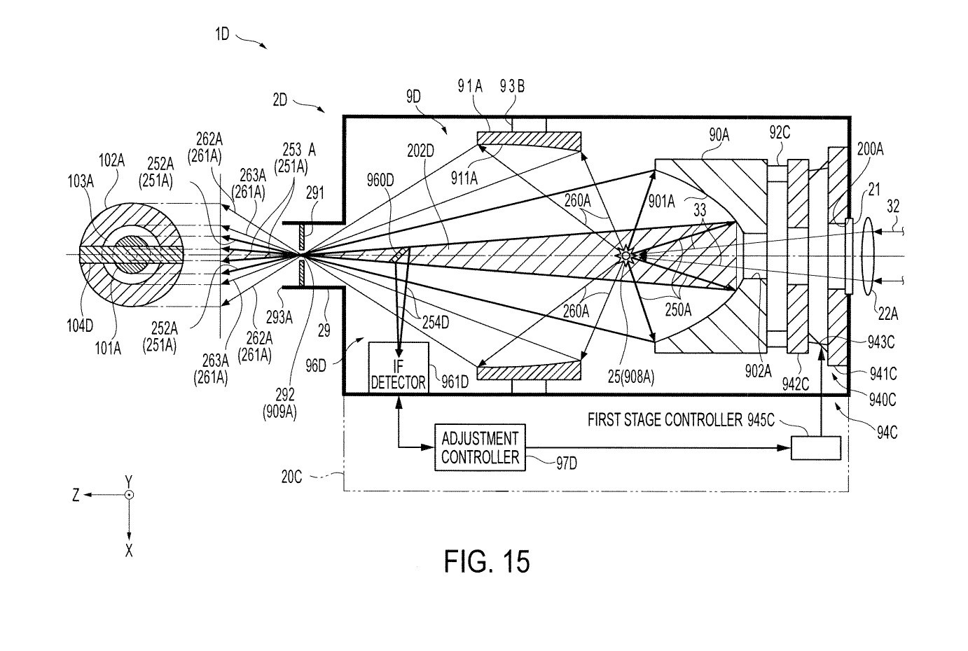

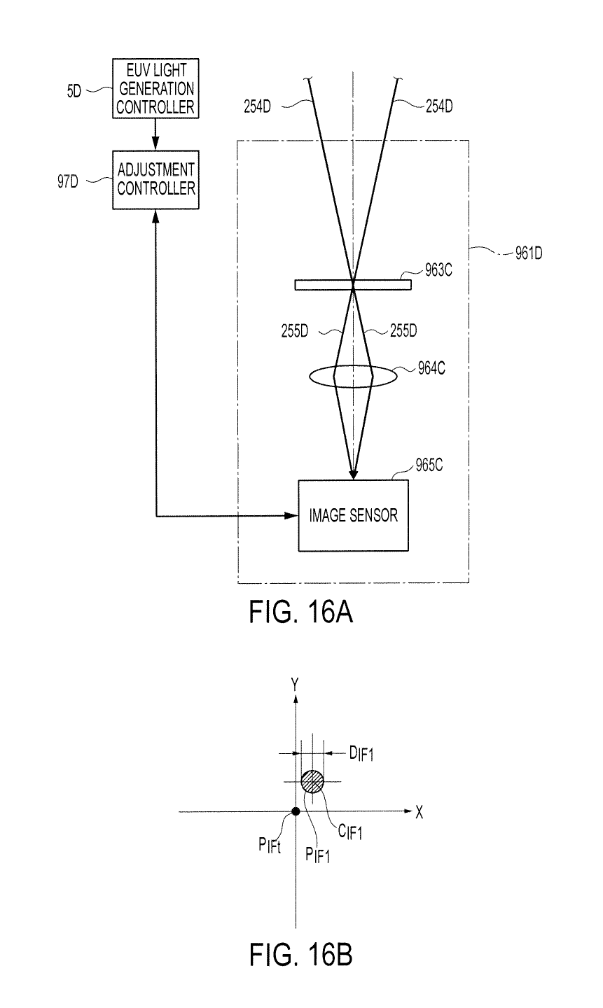

FIG. 14 is a sectional view, taken along a YZ plane, schematically illustrating an exemplary configuration of an EUV light generation apparatus to which a device for collecting EUV light is applied according to a third embodiment of the present disclosure. FIG. 15 is a sectional view schematically illustrating an exemplary configuration of the EUV light generation apparatus, taken along an XZ plane. FIG. 16A shows an example of radiation reflected by the first EUV collector mirror entering a focus detection unit. FIG. 16B shows an example of a result to be obtained by the focus detection unit shown in FIG. 16A.

As shown in FIGS. 14 through 16A, an EUV light generation apparatus 1D of the third embodiment may differ from the EUV light generation apparatus 1C of the second embodiment in that an EUV light generation controller 5D is provided in place of the EUV light generation controller 5C and an EUV light collection device 9D is provided in place of the EUV light collection device 9C. The EUV light collection device 9D may differ from the EUV light collection device 9C in that a focus detection unit 96D and an adjustment controller 97D are provided in place of the focus detection unit 96C and the adjustment controller 97C and in that the second mirror adjuster 95C is not provided. Here, in FIGS. 14 and 15, the pulse laser beam 31 and the laser beam direction control unit 34 are not depicted, but these components may also be provided as in the configuration shown in FIG. 5.

With reference to FIGS. 14 and 15, the focus detection unit 96C may include a splitting optical element 960D and an IF detector 961D. The splitting optical element 960D may be held by a holder 969D such that the splitting optical element 960D is arranged between the plasma generation region 25 and the intermediate focus region 292 in an obscuration region 202D. The obscuration region 202D may be such a solid angle region that radiation traveling therethrough into the exposure apparatus 6 is not used for exposure in exposure apparatus 6. Although a region corresponding to the obscuration region 202D is indicated as a belt-shaped region in the far field pattern in FIGS. 14 and 15, the shape of the obscuration region 202D and the corresponding region in the far field pattern are not limited thereto. The splitting optical element 960D may be arranged in accordance with the shape of the obscuration region 202D. The splitting optical element 960D may be positioned and configured to reflect the radiation 251A with high reflectance toward the IF detector 961D as radiation 254D.

As shown in FIG. 16A, the IF detector 961D may include the fluorescent screen 963C, the transfer optical system 964C, and the image sensor 965C. The fluorescent screen 963C may be positioned such that a distance between the splitting optical element 960D and the intermediate focus region 292 is substantially the same as a distance between the splitting optical element 960D and the fluorescent screen 963C. The transfer optical system 964C may be positioned such that an image of visible light 255D along a plane where the fluorescent screen 963C is arranged is transferred onto the photosensitive surface of the image sensor 965C.

Referring back to FIG. 15, the adjustment controller 97D may be housed in a case 20C of a chamber 2D together with the first stage controller 945C. The adjustment controller 97D may be electrically connected to the EUV light generation controller 5D, the first stage controller 945C, and the image sensor 965C. The adjustment controller 97D may be configured to control the first stage controller 945C in accordance with a calculation result of data obtained from the image sensor 965C.

### 2.5.2 Operation

With reference to FIGS. 14 and 15, the radiation 250A generated in accordance with the control of the EUV light generation controller 5D may be reflected by the first reflective surface 901A and outputted to the exposure apparatus 6 (see FIG. 5) as the radiation 251A. The radiation 260A may be reflected by the second reflective surface 911A and outputted as the radiation 261A to the exposure apparatus 6.

The splitting optical element 960D may be provided in a path of the radiation 251A, as shown in FIG. 15, and thus a part of the radiation 251A traveling through the obscuration region 202D may be reflected by the splitting optical element 960D and directed toward the IF detector 961D as the radiation 254D. Another part of the radiation 251A traveling through a region aside from the obscuration region 202D may be outputted to the exposure apparatus 6.

Accordingly, the first far field pattern 101A, the second far field pattern 102A, and the dark section 103A may be formed inside the exposure apparatus 6. Further, an obscuration region 104D extending in the Y-axis direction may be formed to pass through the centers of the first far field pattern 101A and the second far field pattern 102A. As stated above, radiation traveling in the obscuration region 202D may not be used for exposure in the exposure apparatus 6, and thus even if the radiation in the obscuration region 202D is sampled by the splitting optical element 960D, the exposure performance or throughput of the exposure apparatus 6 is rarely affected.

The EUV light generation controller 5D may output an adjustment start signal to the adjustment controller 97D to carry out the operation shown in FIGS. 9 through 11. Here, Step S2 in FIG. 9 may be omitted from the operation in the third embodiment. As the aforementioned operation is carried out, the difference between the diameter D_{IF1} and the target diameter of the first image P_{IF1} may fall within the predetermined permissible range and the distance between the center C_{IF1} and the target position P_{IFt} may fall within the predetermined permissible range. Thus, the radiation 251A reflected by the first EUV collector mirror 90A may be focused appropriately in the intermediate focus region 292.

As described above, the splitting optical element 960D may be provided in the obscuration region 202D. The IF detector 961D may detect whether or not the radiation 251A is focused in the intermediate focus region 292 based on a result of detecting the radiation 254D reflected by the splitting optical element 960D. The adjustment controller 97D may control the first mirror adjuster 94C based on a result detected by the IF detector 961D so that the radiation 251A is focused in the intermediate focus region 292. In this way, by arranging the splitting optical element 960D in the obscuration region 202D, a loss in the radiation 251A to be used for exposure, which is caused by reflecting a part of the radiation 251A, may be reduced. As a result, without leading to a drop in the efficiency of collecting the radiation 251A used for exposure, the posture of the first EUV collector mirror 90A may be adjusted to focus the radiation 251A appropriately in the intermediate focus region 292.

### 2.6 Fourth Embodiment

### 2.6.1 Configuration

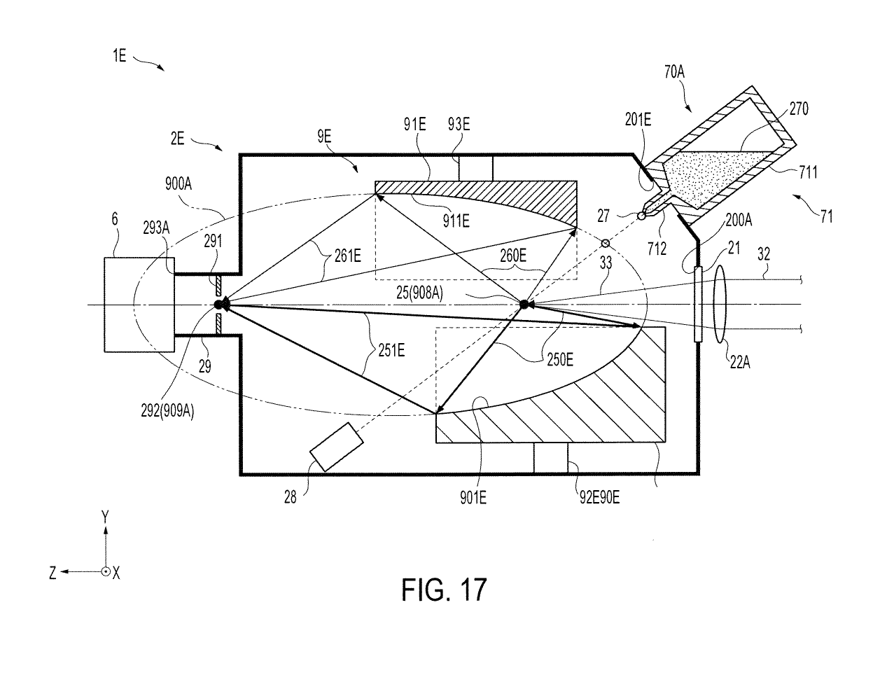

FIG. 17 is a sectional view, taken along a YZ plane, schematically illustrating an exemplary configuration of an EUV light generation apparatus to which a device for collecting EUV light is applied according to a fourth embodiment of the present disclosure.

A second through-hole 201E may be formed in a corner of a chamber 2E of an EUV light generation apparatus 1E, and the target generator 71 may be mounted onto the chamber 2E such that the nozzle 712 is located inside the chamber 2E passing through the second through-hole 201E.

An EUV light collection device 9E may be provided inside the chamber 2E. The EUV light collection device 9E may include a first EUV collector mirror 90E having a first reflective surface 901E and a second EUV collector mirror 91E having a second reflective surface 911E. Each of the first reflective surface 901E and the second reflective surface 911E may be off-axis spheroidal in shape, and may be arranged such that the first reflective surface 901E and the second reflective surface 911E follows along distinct parts of the spheroid 900A. The first EUV collector mirror 90E may be attached to the chamber 2E through a first holder 92E. The second EUV collector mirror 91E may be attached to the chamber 2E through a second holder 93E.

### 2.6.2 Operation

As the target 27 is irradiated with the pulse laser beam 33, radiation including components in EUV range may be emitted isotropically from the plasma generation region 25. Of such radiation, radiation 250E may be reflected by the first reflective surface 901E and focused in the intermediate focus region 292 as radiation 251E. Further, radiation 260E may be reflected by the second reflective surface 911E and focused in the intermediate focus region 292 as radiation 261E. The radiation 251E and the radiation 261E focused in the intermediate focus region 292 may then be outputted to the exposure apparatus 6.

As shown in FIG. 17, the second EUV collector mirror 91E may be arranged closer to the opening 293A than the first EUV collector mirror 90E. This configuration may make it possible to secure a reflective region that overall has a large solid angle without increasing a dimension of the first EUV collector mirror 90E and the second EUV collector mirror 91E in the major axis direction. Accordingly, with the first reflective surface 901E and the second reflective surface 911E each being relatively easy to process with high precision, the radiation 251E and the radiation 261E may be focused in the intermediate focus region 292.

### 3. Configuration of Controller

Those skilled in the art will recognize that the subject matter described herein may be implemented by a general purpose computer or a programmable controller in combination with program modules or software applications. Generally, program modules include routines, programs, components, data structures, and so forth that can perform process as discussed in the present disclosure.

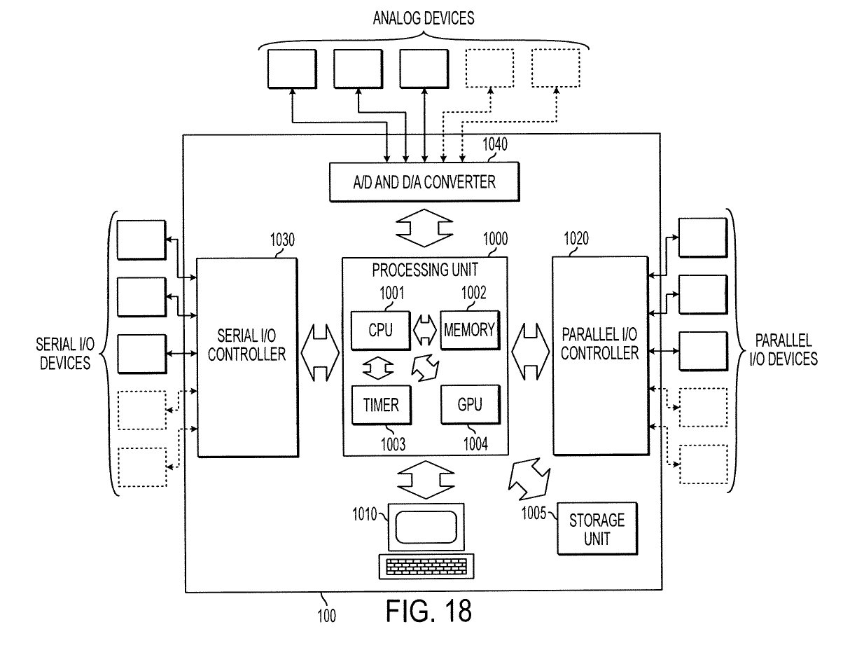

FIG. 18 is a block diagram showing an exemplary hardware environment in which various aspects of the disclosed subject matter may be implemented. An exemplary environment 100 in FIG. 18 may include, but not limited to, a processing unit 1000, a storage unit 1005, a user interface 1010, a parallel input/output (I/O) controller 1020, a serial I/O controller 1030, and an analog-to-digital (A/D) and digital-to-analog (D/A) converter 1040.

The processing unit 1000 may include a central processing unit (CPU) 1001, a memory 1002, a timer 1003, and a graphics processing unit (GPU) 1004. The memory 1002 may include a random access memory (RAM) and a read only memory (ROM). The CPU 1001 may be any of various commercially available processors. Dual microprocessors and other multi-processor architectures may also be employed as the CPU 1001.

These components in FIG. 18 may be interconnected to one another to perform the processes discussed in the present disclosure.

In operation, the processing unit 1000 may load programs stored in the storage unit 1005 to execute them, read data from the storage unit 1005 in accordance with the programs, and write data in the storage unit 1005. The CPU 1001 may execute the programs loaded from the storage unit 1005. The memory 1002 may be a work area to temporally store programs to be executed by the CPU 1001 and data to be used for the operations of the CPU 1001. The timer 116 may measure time intervals to provide the CPU 1001 with a measured result in accordance with the execution of the program. The GPU 1004 may process image data and provide the CPU 1001 with a processing result, in accordance with a program to be loaded from the storage unit 1005.

The parallel I/O controller 1020 may be coupled to parallel I/O devices such as the image sensor 965C, the EUV light generation controllers 5, 5C, and 5D, the adjustment controllers 97C and 97D, the first stage controller 945C, the second stage controller 955C, and the target controller 80, which can communicate with the processing unit 1000, and control communication between the processing unit 1000 and those parallel I/O devices. The serial I/O controller 1030 may be coupled to serial I/O devices such as the image sensor 965C, the shield switching unit 962C, the first adjustment stage 940C, and the second adjustment stage 950C, which can communicate with the processing unit 1000, and control communication between the processing unit 1000 and those serial I/O devices. The A/D and D/A converter 1040 may be coupled to analog devices such as a temperature sensor, a pressure sensor, and a vacuum gauge, through analog ports.

The user interface 1010 may display progress of executing programs by the processing unit 1000 for an operator so that the operator can instruct the processing unit 1000 to stop execution of the programs or to execute an interruption routine.

The exemplary environment 100 can be applicable to implement each of the EUV light generation controllers 5, 5C, and 5D, the adjustment controllers 97C and 97D, the first stage controller 945C, the second stage controller 955C, and the target controller 80 in the present disclosure. Persons skilled in the art will appreciate that those controllers can be implemented in distributed computing environments where tasks are performed by processing units that are linked through any type of a communications network. As discussed in the present disclosure, the EUV light generation controllers 5, 5C, and 5D, the adjustment controllers 97C and 97D, the first stage controller 945C, the second stage controller 955C, and the target controller 80 can be connected to each other through a communication network such as the Ethernet (these controller can be parallel I/O devices as discussed above, when they are connected to each other). In a distributed computing environment, program modules may be located in both local and remote memory storage devices.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A device for collecting EUV light from a plasma generation region, the device comprising:
a first EUV collector mirror having a first spheroidal reflective surface and arranged such that a first focus of the first spheroidal reflective surface lies in the plasma generation region and a second focus of the first spheroidal reflective surface lies in a predetermined intermediate focus region; and
a second EUV collector mirror having a second spheroidal reflective surface and arranged such that a third focus of the second spheroidal reflective surface lies in the plasma generation region and a fourth focus of the second spheroidal reflective surface lies in the predetermined intermediate focus region.

2. The device according to claim 1, further comprising:
a mirror adjuster configured to adjust a posture of at least one of the first and second EUV collector mirrors;
a focus detection unit configured to detect EUV light reflected by the at least one of the first and second EUV collector mirrors; and
an adjustment controller configured to control the mirror adjuster based on a result detected by the focus detection unit such that EUV light from the plasma generation region is focused in the intermediate focus region.
